(19) United States
(12) Patent Application Publication
(10) Pub. No.: US 2004/0190536 A1
(43) Pub. Date: Sep. 30, 2004

(54) Wireless network structure

(75) Inventor: James Wang, Hsinchu Hsien (TW)

Correspondence Address: BRUCE H. TROXELL, SUITE 1404, 5205 LEESBURG PIKE, FALLS CHURCH, VA, 22041, US

(73) Assignees: GemTek Technology Co., Ltd.; SparkLAN Communications, Inc.

(21) Appl. No.: 10/792,879

(22) Filed: Mar. 5, 2004

(30) Foreign Application Priority Data
Mar. 25, 2003 (TW) 92106677

(51) Int. Cl. H04J 3/24

(52) U.S. Cl. 370/401

(57) ABSTRACT

A wireless network structure comprises a number of node apparatuses and a backbone. The node apparatuses are distributed within a specific range of distance, wherein each of the node apparatus comprises a number of wireless bridge modules, a router and a converter. The wireless bridge modules have specific transmission frequency for transmitting packets. The router is connected to the wireless bridge modules. The converter is connected to the router and to a user-end system. The backbone network is applied for transmitting the packets outward the wireless network structure.

### FIELD OF THE INVENTION

The present invention is related to a wireless network structure, more particularly, to a wireless network transmission structure for short-range communication.

### BACKGROUND OF THE INVENTION

As soon as the invention of the Internet, the Internet is integrated into our daily life. Wired communication is applied in the initial Internet. As the demand of wireless communication rises, many wireless technologies were thus invented to match this demand.

At present, the major and popular apparatuses of wireless communication (such as NIC and Access points) are only for applications at the user end, such as families or the local area networks. Concerning the connection to the WAN (Wide Area Network), it is necessary to use the infrastructures provided by ISPs (Internet Service Providers).

Please refer first to FIG. 1, which shows the network structure of the prior art. Whenever a packet is generated by a terminal 13 or the LANs 14, the destination point of the packet is judged by the router in the base station 10 provided by the ISPs. If a packet is generated in the terminal 13 for transmitting to the first LAN 14, the packet will follow the path 11. If the packet is generated for transmitting outside the WAN (such as across the county boundary or state boundary), the packet is transmitted from the base station 10 via the backbone network 12 to the destination point. Actually, many communications are limited at a short-range area, such as communities, campuses, or metropolitan. If all the short-range communications use the backbone networks provided by ISPs, the communication cost will be high and the communication efficiency and stability will be poor. The worst thing is that the small communication company without infrastructure will be excluded from the relevant market by the large communication companies with telecommunication infrastructure.

For this reason, it is very important to invent a wireless transmission system for short-range communication, which needs no backbone network structures.

### SUMMARY OF THE INVENTION

The main object of the present invention is to provide a wireless network structure.

Another object of the present invention is to provide a design for the node apparatus of the wireless network structure.

In accordance with the first embodiment of the present invention, the wireless network structure is composed of a number of node apparatuses. Each node apparatus is comprised of a number of wireless bridge modules, a router, and a converter. The wireless bridge modules have specific transmission frequency for transmitting packets. The router is connected to the wireless bridge modules, and the converter is connected to the router and to a user-end system. The packet will be transmitted to the user-end system via the converter, in case the packet is received by the router via the wireless bridge module from another node structure and designated to the user-end system by means of the predetermined information on the packet. The packet will be transmitted to another designated node apparatus, in case the packet is received by the router via the wireless bridge modules from another node structure but not designated to the user-end system. The packet will be transmitted to another designated node apparatus via the wireless bridge modules, in case the packet is generated by the user-end system.

According to the second embodiment of the present invention, the node apparatus comprises the first wireless bridge router module and the second wireless bridge router module. The first wireless bridge router module is composed of two wireless bridge modules, a router and a converter. The second wireless bridge router module is composed of two wireless bridge modules, a router and a converter. If a packet is generated from one wireless bridge router module but unfortunately it is out of order, the packet will be transmitted to the other wireless bridge router module by the selection of the multi-homing gateway.

### BRIEF DESCRIPTION OF THE DRAWINGS

FIG. 1 shows the network structure according to the prior art.

FIG. 2 shows a number of wireless bridge modules connected to a router and then to a converter.

FIG. 3 shows the schematic diagram of the wireless network structure with connection to the backbone network.

FIG. 4 shows the distribution diagram of the wireless network structure with a plurality of nodes according to the present invention.

FIG. 5 shows the node apparatus according to the second embodiment of the present invention.

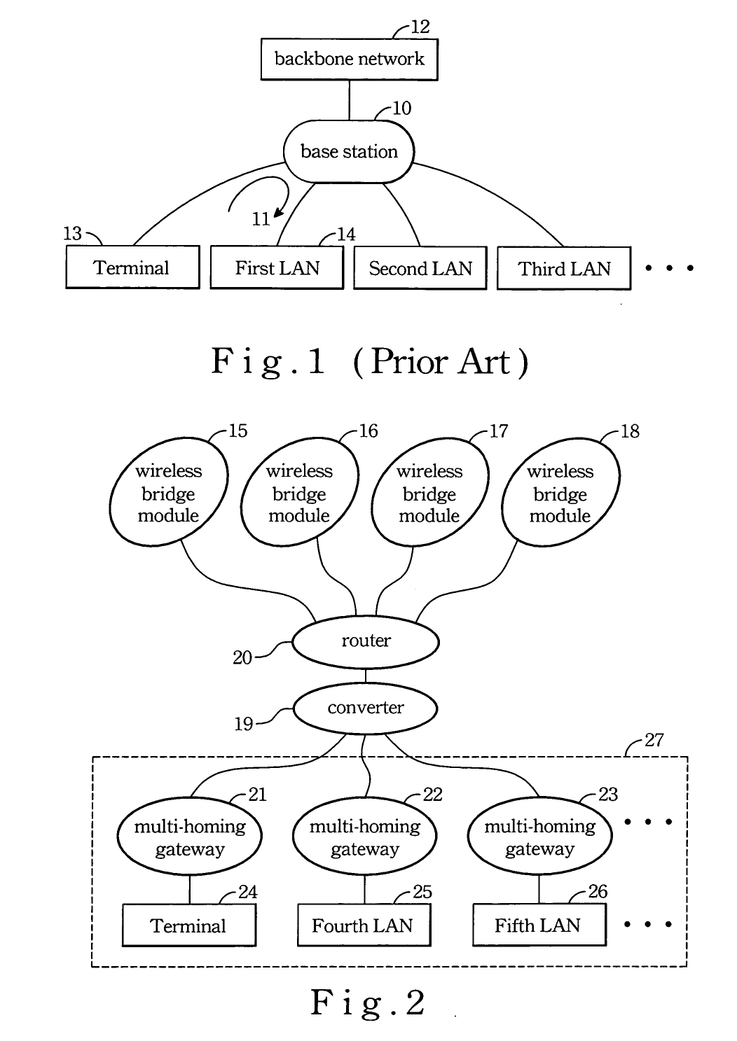

### DESCRIPTION OF THE PREFERRED EMBODIMENTS

The present invention is related to a wireless network structure provided for the wide area networks.

The First Embodiment

According to the first embodiment of the present invention, the wireless network structure without connection to the backbone network is composed of a plurality of nodes within a specific range of distance. Referring now to FIG. 2, a number of wireless bridge modules 15, 16, 17, 18 are connected to a router 20 and then to a converter 19. The converter 19 is then connected to the user end 27. The specific range of distance (about 1000 to 5000 meters) means the best distance for the wireless bridge modules 15, 16, 17, 18 to transmit and receive signals. In order to enhance the transmission efficiency, the wireless bridge modules are generally put up on the top of the tall buildings.

The user end 27 is one end of a terminal 24 or local area network (the fourth LAN 25, the fifth LAN 26), which are connected to the converter 19 via the multi-homing gateway 21, the multi-homing gateway 22 and the multi-homing gateway 23, respectively. The multi-homing gateways 21, 22, 23 are applied for protocol transformation between different types of networks. According to the best embodiment of the present invention, the multi-homing gateway is located on the top of the building, and the user-ends are the local area networks of the building. One example of the wireless bridge module is an access point, which has lots of transmission channels or bands to be selected to meet the transmission standards such as IEEE 802.11X (including 2.4 GHZ and 5.0 GHZ), HiperLAN1/HiperLAN2 or HomeRF in the Industrial Scientific Medical Band.

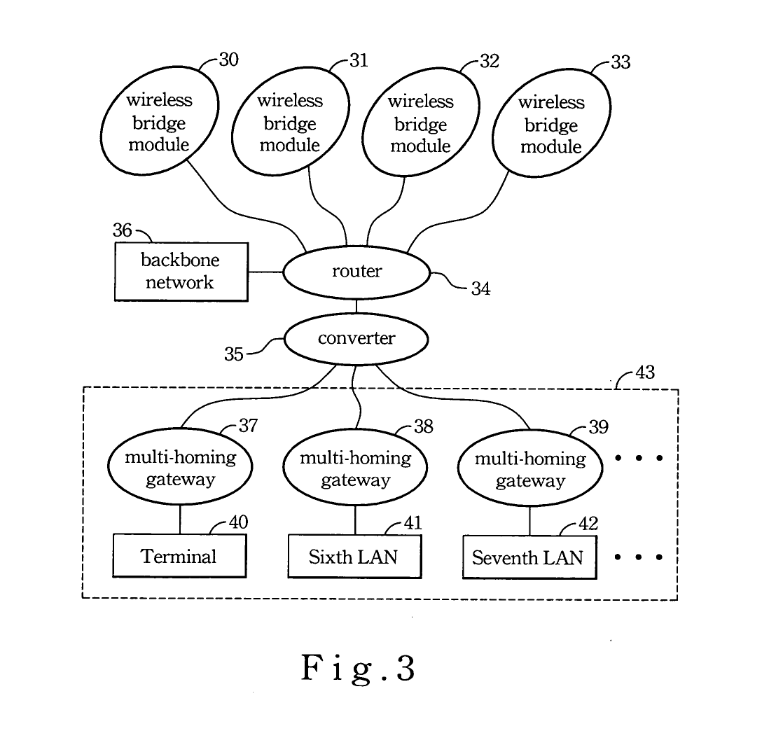

Referring now to FIG. 3, the schematic diagram of the wireless network structure with connection to the backbone network is disclosed. It's not necessary for the backbone network 36 to be connected to each node. The backbone network 36 is connected to only some pre-determined nodes. Only when one packet needs being transmitted outward the wireless network structure, the packet is first transmitted to one of the pre-determined nodes and then transmitted outwards via the backbone network 36. The backbone network 36 is T1, E1, T3, or fiber tube which is infrastructure hired from the Internet service providers.

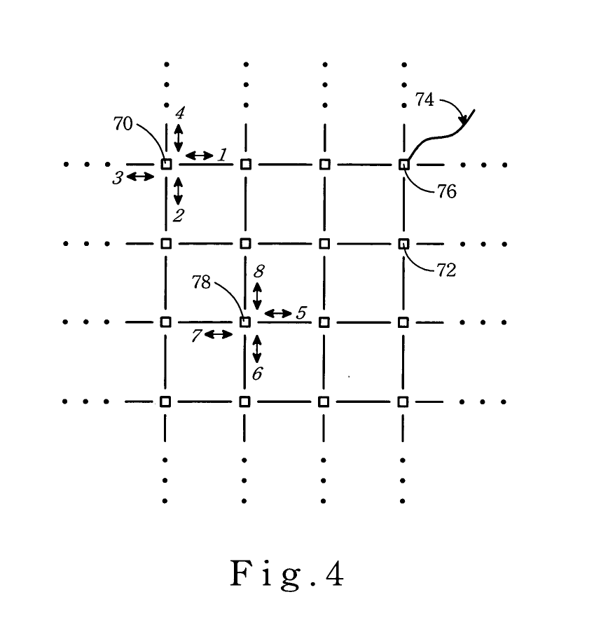

Refer now to FIG. 4, which shows the distribution diagram of the wireless network structure with a plurality of nodes according to the present invention. The transmission channels 1, 2, 3, 4 indicate that the node 70 is applied to integrate four wireless bridge modules. In the best embodiment of the present invention, the highest transmission rate of IEEE802.11g can reach 54 Mbps, so the bandwidth of the mode 70 can be as high as 216 Mb.

An example is disclosed to show how a packet can be transmitted from the node 70 to the node 72. Referring also to FIG. 2, the packet could be generated from the terminal 24, the fourth LAN 25, the fifth LAN 26, or any other nodes in the wireless network structure. The data on the packet will be received and analyzed by the router 20 to obtain some information including the logical addresses of the packet's source point and destination point. The routing table of the best path will also be obtained in accordance with the existed protocol of architectures on the router 20. One of the wireless bridge modules 15, 16, 17, 18 is then selected to transmit the packet to the next node. The processes mentioned above continue and finally the packet is transmitted to the destination node 72. The physical address of the destination point in the packet information is determined by the converter 19, in order for transmitting the packet to the destination point. The co-channel interference can be avoided by selecting different frequency bands. The above-mentioned protocol of architectures could be interior gateway protocol such as routing information protocol (RIP), or exterior gateway protocol such as border gateway protocol (BGP). It should be emphasized that the node 70 may only serve as a relay node. In other word, any node in the wireless network structure could be the generation node of a packet, the relay node of a packet, or a destination node of a packet.

The explanation mentioned above is for the transmission within the wireless network structure. If the packet is needed to be transmitted outside the wireless network structure, the packet will be transmitted by the router 20 to the node connecting to the backbone network, such as node 76 in FIG. 4. The packet will be transmitted to the destination point via the backbone network 74 which is connected to the node 76.

The explanation mentioned above is for the communication in a larger area, such as the network system in a city. In this case, the communication protocol used in the router is the third network layer in the OSI seven-layer structure. For this reason, every wireless bridge module needs an independent IP address, and thus many IP addresses are needed for the whole network system. On the other hand, in the case of smaller area such as a campus or a company, the router can use the second network layer (Data Link Layer) such as STP (Spanning Tree Protocol) FSTP (Fast Spanning Tree Protocol) as the communication protocol. In this case, the demand of the IP addresses can be significantly decreased.

The Second Embodiment

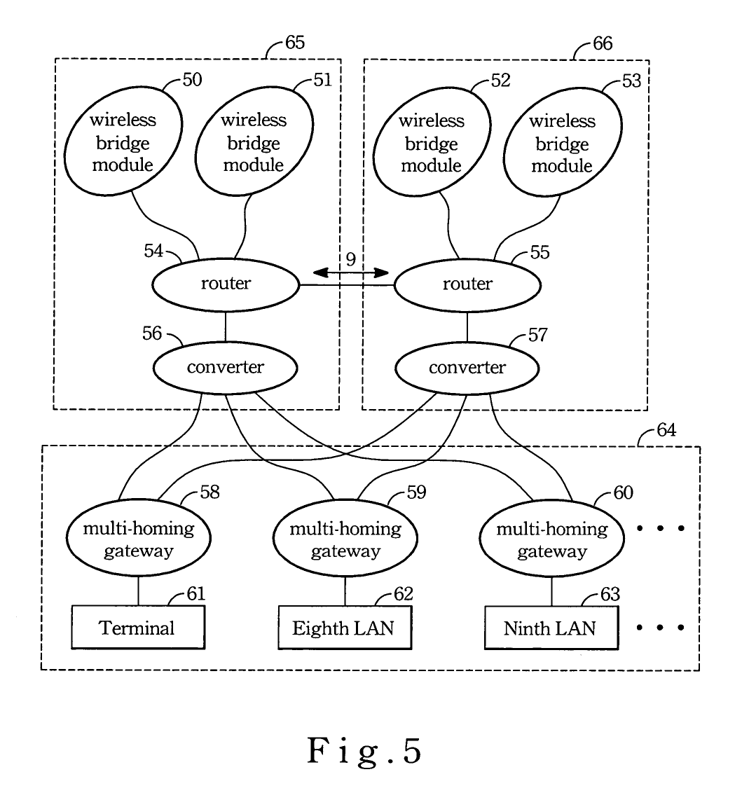

Referring now to FIG. 5, the second embodiment of the present invention is disclosed. The node apparatus in the second embodiment comprises the first wireless bridge router module 65 and the second wireless bridge router module 66. The first wireless bridge router module 65 is composed of two wireless bridge modules 50, 51, a router 54 and a converter 56. The second wireless bridge router module 66 is composed of two wireless bridge modules 52, 53, a router 55 and a converter 57. The first wireless bridge router module 65 and the second wireless bridge router module 66 are connected to the user-end system 64. The user-end system 64 is composed of a terminal 61, the eighth LAN 62, and a ninth LAN 63, and their corresponding multi-homing gateways 58, 59, 60. The multi-homing gateways 58, 59, 60 are connected to the converter 56 and the converter 57. For example, referring to FIG. 4, the node apparatus is indicated by the node 78. The lateral channels 5 and 7 are framed by the first wireless bridge router module 65, and the vertical channels 6 and 8 are framed by the second wireless bridge router module 66. If the node 78 is applied only for transmitting packets, the packet may be received from the vertical channel 6 or 8 to the router 55 via the wireless bridge modules 52, 53. The packet is then analyzed by the router 55 and transmitted to the router 54 in the first wireless bridge router module 65 via the interconnection 9. The packet is then transmitted to the lateral channel 5 or 7 to the designated node point via the wireless bridge module 50 or 51.

In case a packet is generated from the terminal 61 but unfortunately the first wireless bridge router module 65 is out of order, the packet will be transmitted to the second wireless bridge router module 66 by the selection of the multi-homing gateway 58. In addition, the multi-homing gateway 58 has the function of balancing load, in order to balance the loading of the two wireless bridge router modules.

The first advantage of the present invention is to use wireless communication to serve as wide area network. The wireless communication has the merits of portability and convenience. Moreover, an important feature of wireless communication is to provide the feasibility for a company without wired infrastructure to enter the relevant market. The best application of the wireless communication is for the communities, the campuses, and the cities.

Although the present invention has been described in terms of specific exemplary embodiments, it will be appreciated that various modifications and alterations might be made by those skilled in the art without departing from the spirit and scope of the invention as set forth in the following claims.

What is claimed is:

1. A node apparatus for transmitting a packet in a wireless network structure, comprising:
a number of wireless bridge modules with specific transmission frequency for transmitting said packet;
a router, wherein said router is connected to said wireless bridge modules;
a converter, wherein said converter is connected to said router and to a user-end system;
wherein said packet will be transmitted to said user-end system via said converter, in case said packet is received by said router via said wireless bridge module from another node structure and designated to said user-end system by means of predetermined information on said packet;
wherein said packet will be transmitted to another designated node apparatus, in case said packet is received by said router via said wireless bridge modules from another node structure but not designated to said user-end system;
wherein said packet will be transmitted to another designated node apparatus via said wireless bridge modules, in case said packet is generated by said user-end system.

2. The node apparatus of claim 1, wherein said node apparatus further comprises a backbone network for transmitting said packet outward said wireless network structure.

3. The node apparatus of claim 1, wherein said packet is generated from said user-end system.

4. The node apparatus of claim 1, wherein said packet is generated from one of said node apparatuses.

5. The node apparatus of claim 1, wherein said user-end system is a terminal which is connected to said converter via a gateway.

6. The node apparatus of claim 1, wherein said user-end system is a local area network which is connected to said converter via a gateway.

7. The node apparatus of claim 1, wherein said router comprises architecture selected from the group of Spanning Tree Protocol, Fast Spanning Tree Protocol, Routing Information Protocol, Open Shortest Path First, and Border Gateway Protocol.

8. The node apparatus of claim 1, wherein said specific transmission frequency matches the ISM band.

9. A wireless network structure, comprising:
a number of node apparatuses, wherein said node apparatuses are distributed within a specific range of distance, wherein each of said node apparatuses comprises a number of wireless bridge modules, a router and a converter; wherein said wireless bridge modules have specific transmission frequency for transmitting packets; wherein said router is connected to said wireless bridge modules; wherein said converter is connected to said router and to a user-end system;
a backbone network, wherein said backbone network is applied for transmitting said packets outward said wireless network structure;
wherein said packet will be transmitted to said user-end system via said converter, in case said packet is received by said router via said wireless bridge module from another node structure and designated to said user-end system by means of predetermined information on said packet;
wherein said packet will be transmitted to another designated node apparatus, in case said packet is received by said router via said wireless bridge modules from another node structure but not designated to said user-end system;
wherein said packet will be transmitted to another designated node apparatus via said wireless bridge modules, in case said packet is generated by said user-end system.

10. The node apparatus of claim 9, wherein said packet is generated from said user-end system.

11. The node apparatus of claim 9, wherein said packet is generated from one of said node apparatuses.

12. The node apparatus of claim 9, wherein said user-end system is a terminal which is connected to said converter via a gateway.

13. The node apparatus of claim 9, wherein said user-end system is a local area network which is connected to said converter via a gateway.

14. The node apparatus of claim 9, wherein said router comprises architecture selected from the group of Spanning Tree Protocol, Fast Spanning Tree Protocol, Routing Information Protocol, Open Shortest Path First, and Border Gateway Protocol.

15. The node apparatus of claim 9, wherein said specific transmission frequency matches ISM band.
